(19) United States
(12) Patent Application Publication
(10) Pub. No.: US 2026/0257675 A1
(43) Pub. Date: Sep. 3, 2026

(54) DRIVING ASSISTANCE APPARATUS AND DRIVING ASSISTANCE METHOD

(71) Applicant: TOYOTA JIDOSHA KABUSHIKI KAISHA, Toyota-shi (JP)

(72) Inventor: Kazuki FUKAZAWA, Toyota-shi (JP)

(73) Assignee: TOYOTA JIDOSHA KABUSHIKI KAISHA, Toyota-shi (JP)

(21) Appl. No.: 19/545,950

(22) Filed: Feb. 20, 2026

(30) Foreign Application Priority Data
Mar. 3, 2025 (JP) 2025-033143

(51) Int. Cl. B60W 30/09; B60W 50/14

(52) U.S. Cl. CPC B60W 30/09; B60W 50/14; B60W 2554/802; B60W 2710/18

(57) ABSTRACT

The present disclosure provides an apparatus for suppressing occupant discomfort. The apparatus includes a detection unit for detecting a first object and a second object, a notification control unit for issuing a warning when a first condition or a second condition is satisfied, a brake control unit for executing automatic braking, a switching control unit for enabling or disabling the automatic brake, a determination unit configured to determine which object has a higher risk when both conditions are satisfied, and a priority control unit for prioritizing a warning for the higher risk object. The determination unit compares a first predicted collision distance with a corrected second predicted collision distance obtained by adding a correction constant, determines that the object having a smaller value has a higher risk, and sets the correction constant to be smaller when the automatic brake is enabled than when the automatic brake is disabled.

### CROSS-REFERENCE TO RELATED APPLICATION

This application claims priority to Japanese Patent Application No. JP 2025-033143 filed on March 3, 2025, the content of which is hereby incorporated by reference in its entirety into this application.

### BACKGROUND OF THE INVENTION

### Field of the Invention

The present disclosure relates to a driving assistance apparatus and a driving assistance method.

### Description of the Related Art

For example, Japanese Patent Application Laid-Open (kokai) No. 2024-143116 discloses a technique in which, when a first object existing within a predetermined distance range from a host vehicle and a second object approaching the host vehicle from outside the predetermined distance range are simultaneously detected, a warning targeting whichever of the first object and the second object has a higher likelihood of colliding with the host vehicle is issued to an occupant of the host vehicle.

In some cases, two or more objects having different characteristics around a host vehicle are simultaneously detected by different sensors. In such cases, if determination of which object has a higher collision risk is made without considering the influence of sensor detection errors, there is a problem that it becomes difficult to ensure determination accuracy. On the other hand, if such determination is made based on, for example, a maximum value of sensor detection error, a determination result different from an actual risk may be derived. As a result, a warning targeting an object different from an object that an occupant actually perceives as risky may be issued, thereby causing discomfort to the occupant.

### SUMMARY OF THE INVENTION

The present disclosure has been made in view of the above circumstances, and an object thereof is to realize warning notification capable of effectively suppressing discomfort felt by an occupant when two or more objects are detected.

The technology of the present disclosure provides a driving assistance apparatus, comprising:
a first detection unit configured to detect a first object approaching, from outside a first region, toward the first region located in a traveling direction of a host vehicle and within a predetermined first distance range from the host vehicle;
a second detection unit configured to detect a second object present within a second region located in the traveling direction of the host vehicle and within a predetermined second distance range from the host vehicle;
a notification control unit configured to issue a warning to an occupant of the host vehicle when either
   (i) a first notification condition is satisfied in which a first collision risk between the first object detected by the first detection unit and the host vehicle reaches a predetermined first level, or
   (ii) a second notification condition is satisfied in which a second collision risk between the second object detected by the second detection unit and the host vehicle reaches a predetermined second level;
an automatic brake control unit configured to execute automatic braking by actuating a braking device of the host vehicle to apply braking force to the host vehicle when at least one of the first collision risk and the second collision risk reaches a predetermined third level;
a switching control unit configured to switch the automatic brake between an enabled state in which the automatic brake is executable and a disabled state in which the automatic brake is not executable, in accordance with satisfaction of a predetermined switching condition;
a risk determination unit configured to determine which of the first object and the second object has a higher collision risk when both the first notification condition and the second notification condition are satisfied; and
a priority control unit configured to control the notification control unit to preferentially issue a warning targeting the object determined by the risk determination unit to have the higher collision risk,
wherein the risk determination unit
   acquires a first predicted collision position at which the host vehicle is predicted to collide with the first object and a second predicted collision position at which the host vehicle is predicted to collide with the second object,
   compares a first predicted collision distance from the host vehicle to the first predicted collision position with a corrected second predicted collision distance obtained by adding a predetermined correction constant to a second predicted collision distance from the host vehicle to the second predicted collision position, and
   determines that the object having a smaller value has the higher collision risk, and
wherein the risk determination unit sets the correction constant to be smaller when the automatic brake is switched to the enabled state by the switching control unit than when the automatic brake is switched to the disabled state.

### BRIEF DESCRIPTION OF THE DRAWINGS

FIG. 1 is a schematic diagram illustrating a hardware configuration of a vehicle according to the present embodiment.

FIG. 2A is a schematic diagram illustrating an example of vehicle-mounted positions of a rear camera sensor, a left rear side radar sensor, and a right rear side radar sensor.

FIG. 2B is a schematic diagram illustrating an example of vehicle-mounted positions of a left rear side sonar sensor, a left rear sonar sensor, a right rear sonar sensor, and a right rear side sonar sensor.

FIG. 3 is a schematic diagram illustrating a software configuration of a control apparatus according to the present embodiment.

FIG. 4 is a schematic diagram for explaining processing performed when a rear moving object and a rear stationary object are detected in a rear region of a host vehicle.

FIG. 5 is a flowchart illustrating routines of collision risk determination processing, priority processing, and notification processing according to the present embodiment.

### DESCRIPTION OF THE EMBODIMENTS

Hereinafter, a driving assistance apparatus and a driving assistance method according to the present embodiment will be described with reference to the drawings.

### Hardware Configuration

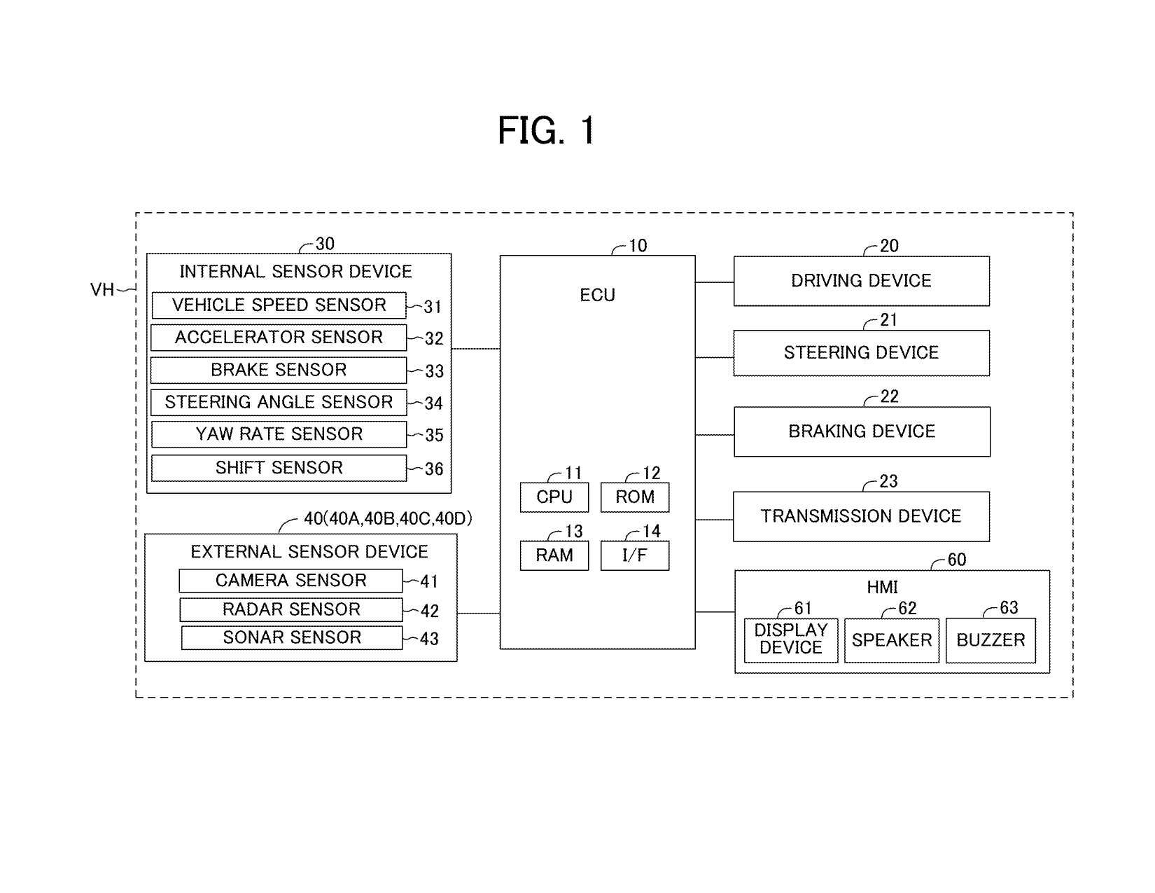

FIG. 1 is a schematic diagram illustrating a hardware configuration of a vehicle VH according to the present embodiment. In the following description, the vehicle VH may also be referred to as a host vehicle when it is necessary to distinguish it from other vehicles and the like.

The vehicle VH includes an ECU (Electronic Control Unit) 10. The ECU 10 includes a CPU (Central Processing Unit) 11, a ROM (Read Only Memory) 12, a RAM (Random Access Memory) 13, an interface device 14, and the like. The CPU 11 is a processor that executes various programs stored in the ROM 12. The ROM 12 is a nonvolatile memory and stores data and the like necessary for the CPU 11 to execute various programs. The RAM 13 is a volatile memory and provides a work area expanded when various programs are executed by the CPU 11. The interface device 14 is a communication device for communicating with an external device.

The ECU 10 is a central device that performs driving assistance such as notification control. Driving assistance is a concept that includes autonomous driving. A drive device 20, a steering device 21, a braking device 22, a transmission device 23, an internal sensor device 30, an external environment sensor device 40, an HMI (Human Machine Interface) 60, and the like are communicably connected to the ECU 10.

The drive device 20 generates driving force transmitted to drive wheels of the vehicle VH. Examples of the drive device 20 include an electric motor and an engine. The steering device 21 applies steering force to wheels of the vehicle VH. The braking device 22 applies braking force to the wheels of the vehicle VH. The transmission device 23 decelerates rotational power output from the drive device 20 at a predetermined gear ratio and transmits the rotational power to the drive wheels.

The internal sensor device 30 is a group of sensors that detect a state of the vehicle VH. The internal sensor device 30 includes, for example, a vehicle speed sensor 31, an accelerator sensor 32, a brake sensor 33, a steering angle sensor 34, a yaw rate sensor 35, a shift sensor 36, and the like. The internal sensor device 30 repeatedly transmits the state of the vehicle VH detected by the sensors 31 to 36 to the ECU 10 at a predetermined cycle.

The vehicle speed sensor 31 detects a traveling speed (hereinafter referred to as vehicle speed) of the vehicle VH. The accelerator sensor 32 detects an operation amount of an accelerator pedal (not illustrated) operated by a driver. The brake sensor 33 detects an operation amount of a brake pedal (not illustrated) operated by the driver. The steering angle sensor 34 detects a rotation angle of a steering wheel or a steering shaft (not illustrated) of the vehicle VH, that is, a steering angle. The yaw rate sensor 35 detects a yaw rate of the vehicle VH. The shift sensor 36 detects a shift position (parking P, reverse R, neutral N, drive D, and the like) of the transmission device 23.

The external environment sensor device 40 is a group of sensors that acquires object information regarding objects present around the vehicle VH (surrounding objects). Examples of the surrounding objects include moving objects such as other vehicles and pedestrians, and stationary objects such as walls and poles. The external environment sensor device 40 repeatedly transmits acquired object information of the surrounding objects to the ECU 10 at a predetermined cycle.

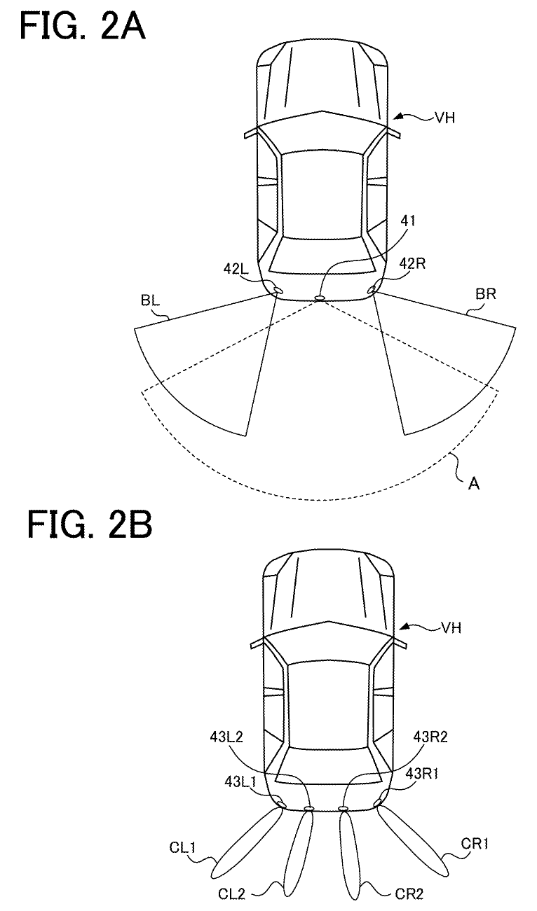

The camera sensor 41 is, for example, a stereo camera or a monocular camera, and a digital camera having an image sensor such as a CMOS or a CCD can be used. The camera sensor 41 captures images of surroundings of the vehicle VH, and acquires object information of surrounding objects by processing captured image data. The object information represents information such as a type of a surrounding object, a relative distance between the vehicle VH and the surrounding object, and a relative speed between the vehicle VH and the surrounding object. The type of the surrounding object may be recognized by, for example, machine learning such as pattern matching. In the present embodiment, the camera sensor 41 includes, for example, a rear camera sensor 41R (see FIG. 2A).

The radar sensor 42 includes a millimeter-wave radar and/or a LiDAR. The millimeter-wave radar emits millimeter-wave radio waves and receives millimeter-wave radio waves reflected by surrounding objects present within an emission range. Based on a phase difference between transmitted millimeter waves and received reflected waves, an attenuation level of the reflected waves, a time from transmission of the millimeter waves to reception of the reflected waves, and the like, the millimeter-wave radar acquires a relative distance between the vehicle VH and a surrounding object, a relative speed between the vehicle VH and the surrounding object, and the like. The LiDAR scans pulse-shaped laser light having a wavelength shorter than that of millimeter waves sequentially in a plurality of directions, and acquires a shape of a surrounding object, a relative distance between the vehicle VH and the surrounding object, a relative speed between the vehicle VH and the surrounding object, and the like by receiving reflected light reflected by the object. In the present embodiment, the radar sensor 42 includes, for example, a left rear side radar sensor 42L and a right rear side radar sensor 42R (both see FIG. 2A).

The sonar sensor 43 emits ultrasonic waves to a predetermined range around the vehicle VH. The sonar sensor 43 receives reflected waves reflected by surrounding objects present within an emission range of the ultrasonic waves, and detects presence or absence of surrounding objects and a distance between the vehicle VH and the surrounding objects based on a time from transmission to reception of the ultrasonic waves. The sonar sensor 43 can detect surrounding objects located substantially in front by emitting ultrasonic waves having high directivity. In the present embodiment, the sonar sensor 43 includes, for example, a left rear side sonar sensor 43L1, a left rear sonar sensor 43L2, a right rear sonar sensor 43R2, a right rear side sonar sensor 43R1, and the like (all see FIG. 2B).

In the following description, among surrounding objects present in a rear region of the host vehicle VH, stationary objects such as walls and poles that are close to the host vehicle VH during reverse traveling are referred to as "rear stationary objects." The rear stationary objects are an example of a second object of the present disclosure. Further, among surrounding objects present in the rear region of the host vehicle VH, moving objects such as other vehicles and pedestrians that approach the host vehicle VH during reverse traveling are referred to as "rear moving objects." The rear moving objects are an example of a first object of the present disclosure.

FIG. 2A is a schematic diagram illustrating an example of vehicle-mounted positions of the rear camera 41, the left rear side radar sensor 42L, and the right rear side radar sensor 42R. As illustrated in FIG. 2A, the rear camera 41 is provided, for example, at a substantially central portion in a vehicle width direction of a rear bumper of the vehicle VH. An imaging region A of the rear camera 41 is a wide-angle region that extends rearward of the vehicle VH from the substantially central portion in the vehicle width direction of the rear bumper. The left rear side radar sensor 42L is provided, for example, at a left end portion inside the rear bumper. The right rear side radar sensor 42R is provided, for example, at a right end portion inside the rear bumper. A detection region BL of the left rear side radar sensor 42L is a wide-angle region that extends left-rearward from the left end portion of the rear bumper. A detection region BR of the right rear side radar sensor 42R is a wide-angle region that extends right-rearward from the right end portion of the rear bumper.

The rear camera 41 mainly detects rear moving objects present in the imaging region A. The left rear side radar sensor 42L mainly detects rear moving objects present in the detection region BL. The right rear side radar sensor 42R mainly detects rear moving objects present in the detection region BR. In the following description, the rear camera 41, the left rear side radar sensor 42L, and the right rear side radar sensor 42R are collectively referred to as a rear moving object detection sensor 40A. The imaging region A, the detection region BL, and the detection region BR are examples of a first region of the present disclosure. The rear moving object detection sensor 40A is an example of a first detection unit of the present disclosure.

FIG. 2B is a schematic diagram illustrating an example of vehicle-mounted positions of the left rear side sonar sensor 43L1, the left rear sonar sensor 43L2, the right rear sonar sensor 43R2, and the right rear side sonar sensor 43R1. As illustrated in FIG. 2B, the left rear side sonar sensor 43L1 is provided at a left end portion of the rear bumper, and the right rear side sonar sensor 43R1 is provided at a right end portion of the rear bumper. A detection region CL1 of the left rear side sonar sensor 43L1 is a relatively narrow region extending left-rearward from the left end portion of the rear bumper. A detection region CR1 of the right rear side sonar sensor 43R1 is a relatively narrow region extending right-rearward from the right end portion of the rear bumper. The left rear sonar sensor 43L2 is provided between the left end portion and a central portion in a vehicle width direction of the rear bumper, and the right rear sonar sensor 43R2 is provided between the right end portion and the central portion in the vehicle width direction of the rear bumper. A detection region CL2 of the left rear sonar sensor 43L2 is a relatively narrow region extending left-rearward from between the left end portion and the central portion. A detection region CR2 of the right rear sonar sensor 43R2 is a relatively narrow region extending right-rearward from between the right end portion and the central portion.

The left rear side sonar sensor 43L1 mainly detects rear stationary objects present in the detection region CL1. The left rear sonar sensor 43L2 mainly detects rear stationary objects present in the detection region CL2. The right rear side sonar sensor 43R1 mainly detects rear stationary objects present in the detection region CR1. The right rear sonar sensor 43R2 mainly detects rear stationary objects present in the detection region CR2. In the following description, the left rear side sonar sensor 43L1, the left rear sonar sensor 43L2, and the right rear sonar sensor 43R2 are collectively referred to as a rear stationary object detection sensor 40B. The detection regions CL1, CL2, CR1, and CR2 are examples of a second region of the present disclosure. The rear stationary object detection sensor 40B is an example of a second detection unit of the present disclosure.

Returning to FIG. 1, the HMI 60 is an interface for inputting and outputting information between the ECU 10 and an occupant (mainly a driver) of the vehicle VH, and includes an input device and an output device. Examples of the input device include a touch panel, a switch, a voice input microphone, and the like. Examples of the output device include a display device 61, a speaker 62, a buzzer 63, and the like. The display device 61 is, for example, a center display installed on an instrument panel, a multi-information display, a head-up display, a display of a navigation system, and the like. The speaker 62 is, for example, a speaker of an audio system or a navigation system.

### Software Configuration

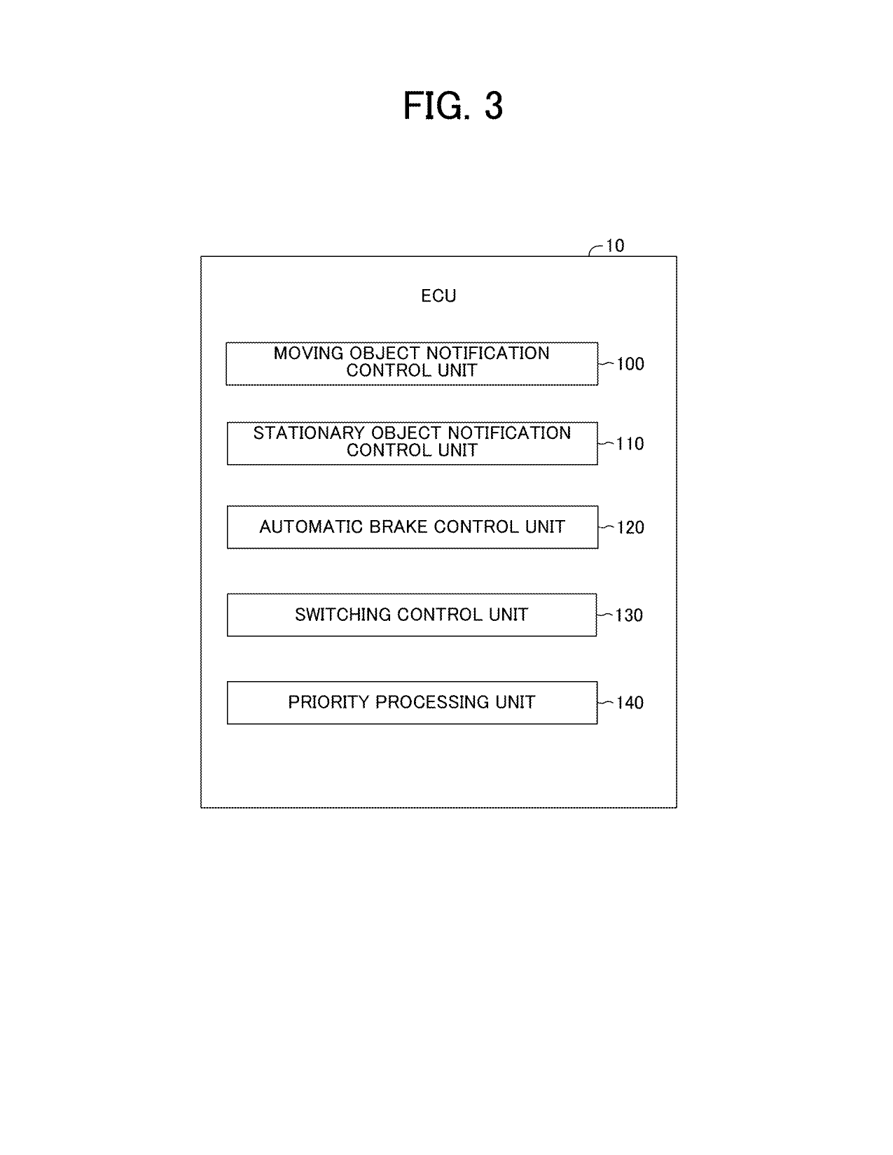

FIG. 3 is a schematic diagram illustrating a software configuration of the ECU 10 according to the present embodiment. As illustrated in FIG. 3, the ECU 10 includes, as functional elements, a moving object notification control unit 100, a stationary object notification control unit 110, an automatic brake control unit 120, a switching control unit 130, a priority processing unit 140, and the like. These functional elements 100 to 140 are implemented by the CPU 11 of the ECU 10 reading programs stored in the ROM 12 into the RAM 13 and executing the programs. Note that all or part of the functional elements 100 to 140 may be provided in another ECU separate from the ECU 10, or in an information processing apparatus of a facility (such as a management center) that is communicable with the vehicle VH.

The moving object notification control unit 100 is an example of the notification control unit of the present disclosure, and executes moving object notification processing for warning an occupant of the host vehicle VH of approach of a rear moving object when, during reverse traveling of the host vehicle VH, a rear moving object such as another vehicle or a pedestrian approaches, from outside of the rear region, a rear region (a first region of the present disclosure) that is within a predetermined distance range behind the host vehicle VH. Such a warning function for a rear moving object is also referred to as a rear cross traffic alert (RCTA) function or a rear camera detection (RCD) function.

Specifically, while the host vehicle VH is reverse-traveling at a predetermined speed (for example, a low speed), the moving object notification control unit 100 detects a rear moving object approaching the rear region of the host vehicle VH based on detection results of the rear moving object detection sensor 40A. The vehicle speed of the host vehicle VH may be acquired based on a detection result of the vehicle speed sensor 31. Whether the host vehicle VH is reverse-traveling may be determined, for example, by determining that the host vehicle VH is reverse-traveling when the shift sensor 36 detects reverse R as a shift position. Note that the traveling direction of the host vehicle VH may be determined based on a rotation direction of wheels detected by the vehicle speed sensor 31 (wheel speed sensor), or based on a change in a road surface image captured by the camera sensor 41, and the like.

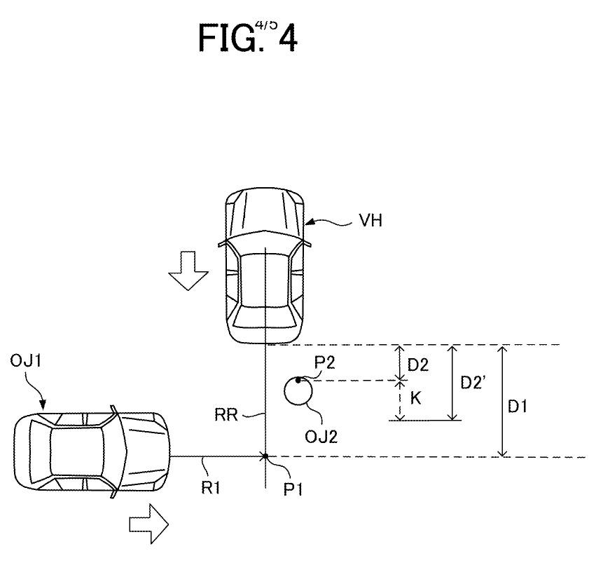

As illustrated in FIG. 4, when the moving object notification control unit 100 detects a rear moving object OJ1, the moving object notification control unit 100 acquires coordinate information of the rear moving object OJ1 based on detection results of the rear moving object detection sensor 40A, and calculates a trajectory R1 of the rear moving object OJ1 based on the acquired coordinate information. The moving object notification control unit 100 estimates, as a position at which the host vehicle VH and the rear moving object OJ1 are predicted to collide (hereinafter referred to as a first predicted collision position P1), a position where the trajectory R1 of the rear moving object OJ1 intersects an extension line RR that passes through a center of the host vehicle VH and extends rearward of the vehicle body. Note that the extension line RR may be a trajectory of the host vehicle VH calculated based on detection results of the vehicle speed sensor 31, the steering angle sensor 34, and the yaw rate sensor 35. When an execution condition (a first notification condition of the present disclosure) is satisfied in which a distance D1 from the host vehicle VH to the first predicted collision position P1 becomes equal to or less than a predetermined first threshold value D1v, the moving object notification control unit 100 executes the moving object notification processing. The moving object notification processing may be executed, for example, by sounding an alarm sound from the speaker 62 or the buzzer 63. Note that the moving object notification processing may be performed in parallel with warning display on the display device 61.

The stationary object notification control unit 110 is an example of the notification control unit of the present disclosure, and executes stationary object notification processing for warning an occupant of the host vehicle VH of proximity to a rear stationary object when, during reverse traveling of the host vehicle VH, the host vehicle VH comes close to a stationary object such as a wall or a pole present in a rear region (a second region of the present disclosure) within a predetermined distance range behind the host vehicle VH. Specifically, while the host vehicle VH is reverse-traveling at a predetermined speed (for example, a low speed), the stationary object notification control unit 110 detects a rear stationary object present in the rear region of the host vehicle VH based on detection results of the rear stationary object detection sensor 40B. The vehicle speed of the host vehicle VH may be acquired based on the detection result of the vehicle speed sensor 31. Whether the host vehicle VH is reverse-traveling may be determined, for example, by determining that the host vehicle VH is reverse-traveling when the shift sensor 36 detects reverse R as the shift position. Note that the traveling direction of the host vehicle VH may be determined based on the rotation direction of wheels detected by the vehicle speed sensor 31 (wheel speed sensor), or based on a change in a road surface image captured by the camera sensor 41, and the like.

As illustrated in FIG. 4, based on detection results of the rear stationary object detection sensor 40B, the stationary object notification control unit 110 acquires a position of a rear stationary object OJ2 with respect to the host vehicle VH, that is, a position at which the host vehicle VH is predicted to collide with the rear stationary object OJ2 (hereinafter referred to as a second predicted collision position P2). When an execution condition (a second notification condition of the present disclosure) is satisfied in which a distance D2 from the host vehicle VH to the second predicted collision position P2 becomes equal to or less than a predetermined second threshold value D2v, the stationary object notification control unit 110 executes the stationary object notification processing. The stationary object notification processing may be executed, for example, by sounding an alarm sound from the speaker 62 or the buzzer 63. Note that the stationary object notification processing may be performed in parallel with warning display on the display device 61.

The automatic brake control unit 120 executes automatic brake control for forcibly decelerating the host vehicle VH when, during reverse traveling of the host vehicle VH, a rear moving object approaches the host vehicle VH, or when the host vehicle VH approaches a rear stationary object. Specifically, when, during reverse traveling of the host vehicle VH, a distance D1 from the host vehicle VH to the first predicted collision position P1 or a distance D2 from the host vehicle VH to the second predicted collision position P2 becomes equal to or less than a predetermined third threshold value D3v, the automatic brake control unit 120 executes an automatic brake that actuates the braking device 22 to automatically apply braking force to the host vehicle VH. The third threshold value D3v is not particularly limited, but may be at least a value smaller than the first threshold value D1v and the second threshold value D2v.

The switching control unit 130 executes switching control to switch the automatic brake between an enabled state (ON) in which the automatic brake can be operated and a disabled state (OFF) in which the automatic brake cannot be operated, in accordance with an ON operation or an OFF operation of an automatic brake switch by an occupant of the host vehicle VH. The operation input by the occupant may be received, for example, through the HMI 60. Note that the ON or OFF of the automatic brake may be configured to be automatically switched to OFF, for example, when the occupant of the host vehicle VH selects an off-road traveling mode. The selection of the off-road traveling mode may also be received through the HMI 60.

By the way, as illustrated in FIG. 4, suppose that, when a rear moving object OJ1 and a rear stationary object OJ2 are simultaneously detected in the rear region of the host vehicle VH, execution conditions for both the moving object notification processing and the stationary object notification processing are satisfied. In such a situation, if both alarm sounds are sounded simultaneously, it will give an occupant of the host vehicle inconvenience or cause confusion. Accordingly, it is desired to compare collision risks of the rear moving object OJ1 and the rear stationary object OJ2 and to preferentially warn of whichever of the rear moving object OJ1 and the rear stationary object OJ2 has a higher collision risk.

As a method for determining which collision risk is higher, it is conceivable to simply compare a distance D1 from the host vehicle VH to the first predicted collision position P1 (hereinafter referred to as a first distance) with a distance D2 from the host vehicle VH to the second predicted collision position P2 (hereinafter referred to as a second distance). However, with the method of simply comparing the first distance D1 and the second distance D2, there is a concern that erroneous determination may be caused due to an influence of sensor detection errors. As an example, although, in reality, the rear stationary object OJ2 exists farther than the rear moving object OJ1 with respect to the host vehicle VH, the second distance D2 may be detected as smaller than the first distance D1 due to an influence of a detection error of the rear stationary object detection sensor 40B (sonar sensor 43). In such a case, there is a problem that, by erroneously determining that the collision risk of the rear stationary object OJ2, which is actually farther, is high and preferentially warning of the rear stationary object OJ2, a possibility of collision between the host vehicle VH and the rear moving object OJ1 is increased.

As a method for eliminating the influence of sensor detection errors, it is conceivable to preferentially issue a warning targeting the rear moving object OJ1 only when the rear moving object OJ1 is farther than the rear stationary object OJ2 by at least a certain amount with respect to the host vehicle VH. Specifically, the first distance D1 is compared with a value (D2 + K) obtained by adding a predetermined buffer constant K (correction constant) to the second distance D2. In this case, in order to ensure safety, it is desirable to set the buffer constant K to a value obtained by accumulating a worst value (maximum value) of sensor detection errors.

However, if the buffer constant K is set to be large by accumulating worst values, there may arise a case where a difference occurs between a driver's sense (an object that the driver actually feels is close) and an object to be preferentially warned of. As an example, although, in reality, the rear stationary object OJ2 exists closer than the rear moving object OJ1 with respect to the host vehicle VH and the driver feels that the rear stationary object OJ2 is dangerous, the apparatus may determine that the collision risk of the rear moving object OJ1 is high. In such a case, if a warning targeting the rear moving object OJ1, which differs from the driver's sense, is issued, the driver will feel discomfort.

That is, it is desired to provide warning notification capable of effectively suppressing a decrease in safety due to sensor detection errors while effectively suppressing a driver's discomfort. Hereinafter, details of the priority processing unit 140, which is a functional element for achieving both of these, will be described.

When a rear moving object OJ1 and a rear stationary object OJ2 are simultaneously detected in the rear region of the host vehicle VH and execution conditions for both the moving object notification processing and the stationary object notification processing are satisfied, the priority processing unit 140 executes collision risk determination processing for determining which of the rear moving object OJ1 and the rear stationary object OJ2 has a higher collision risk. In addition, when the priority processing unit 140 determines that the collision risk of the rear moving object OJ1 is high, the priority processing unit 140 executes priority processing to prioritize the moving object notification processing by the moving object notification control unit 100, and when the priority processing unit 140 determines that the collision risk of the rear stationary object OJ2 is high, the priority processing unit 140 executes priority processing to prioritize the stationary object notification processing by the stationary object notification control unit 110. The priority processing unit 140 is an example of the risk determination unit and the priority control unit of the present disclosure. Note that, in the present disclosure, prioritizing notification processing (sounding of an alarm sound) may include, in addition to an aspect in which only an alarm sound having a higher priority is sounded, an aspect in which a volume of the alarm sound having a higher priority is increased.

In the present embodiment, the priority processing unit 140 changes the buffer constant K used for the collision risk determination processing depending on whether the automatic brake is ON or OFF. The buffer constant K is an example of the correction constant of the present disclosure. Hereinafter, details of the collision risk determination processing will be described.

The priority processing unit 140 compares the first distance D1 acquired based on detection results of the rear moving object detection sensor 40A with a value obtained by adding a predetermined buffer constant K to the second distance D2 acquired based on detection results of the rear stationary object detection sensor 40B (hereinafter referred to as a corrected second distance D2'). If the first distance D1 is smaller than the corrected second distance D2', the priority processing unit 140 determines that the collision risk of the rear moving object OJ1 is high. On the other hand, if the corrected second distance D2' is smaller than the first distance D1, the priority processing unit 140 determines that the collision risk of the rear stationary object OJ2 is high.

### Automatic Brake ON

When the automatic brake is ON, the automatic brake control unit 120 executes the automatic brake so as to avoid collision between the host vehicle VH and the rear moving object OJ1 or the rear stationary object OJ2, or to reduce collision damage, including the influence of sensor detection errors. That is, it can be said that this is a situation in which safety can be effectively ensured by the automatic brake. Accordingly, when the automatic brake is ON, as an alarm function, it is desirable to issue warnings that match a driver's sense in more scenes rather than considering the worst value of sensor detection errors.

When the automatic brake is ON, the priority processing unit 140 sets the buffer constant K to a relatively small first buffer constant K1. The first buffer constant K1 only needs to be a value smaller than a second buffer constant K2 described later, and may be 0 (0 ≤ K1 < K2). In this manner, when the automatic brake is ON, by setting the first buffer constant K1 to a relatively small value or to 0, for example, in a situation where the rear stationary object OJ2 is actually closer to the host vehicle VH than the rear moving object OJ1, a warning targeting the rear stationary object OJ2 for which collision is expected earlier is more likely to be prioritized. That is, it is possible to make it easier to prioritize a warning targeting an object for which the driver actually feels a risk. Accordingly, it becomes possible to effectively suppress giving discomfort to the driver.

### Automatic Brake OFF

On the other hand, when the automatic brake is OFF, collision avoidance between the host vehicle VH and a rear object is entrusted to a driver's driving operation. Accordingly, if the driver does not perform a brake operation, or if a brake operation is delayed, and the host vehicle VH collides with a rear object, collision damage becomes larger than when the automatic brake is ON. In particular, when the host vehicle VH collides with the rear moving object OJ1, collision damage becomes larger than when the host vehicle VH collides with the rear stationary object OJ2. Accordingly, when the automatic brake is OFF, it is desirable to avoid a situation in which the host vehicle VH collides with the rear moving object OJ1 without being able to warn of the rear moving object OJ1 for which collision damage becomes large. That is, it can be said that this is a situation in which it is desirable to determine collision risks in consideration of the influence of sensor detection errors.

When the automatic brake is OFF, the priority processing unit 140 sets the buffer constant K to a relatively large second buffer constant K2. The second buffer constant K2 only needs to be a value larger than the first buffer constant K1 (K2 > K1), and may be set to, for example, a value obtained by accumulating a worst value of sensor detection errors. In this manner, when the automatic brake is OFF, by setting the second buffer constant K2 to a relatively large value or to a value obtained by accumulating a worst value of sensor detection errors, it becomes possible to effectively eliminate the influence of sensor detection errors. Accordingly, in a situation where the rear moving object OJ1 is actually closer to the host vehicle VH than the rear stationary object OJ2, it becomes possible to effectively prevent a warning targeting the rear stationary object OJ2 having a low collision risk from being prioritized. That is, it becomes possible to effectively suppress collision of the host vehicle VH with the rear moving object OJ1 without being able to warn of the rear moving object OJ1 for which collision damage becomes large, thereby making it possible to effectively ensure safety.

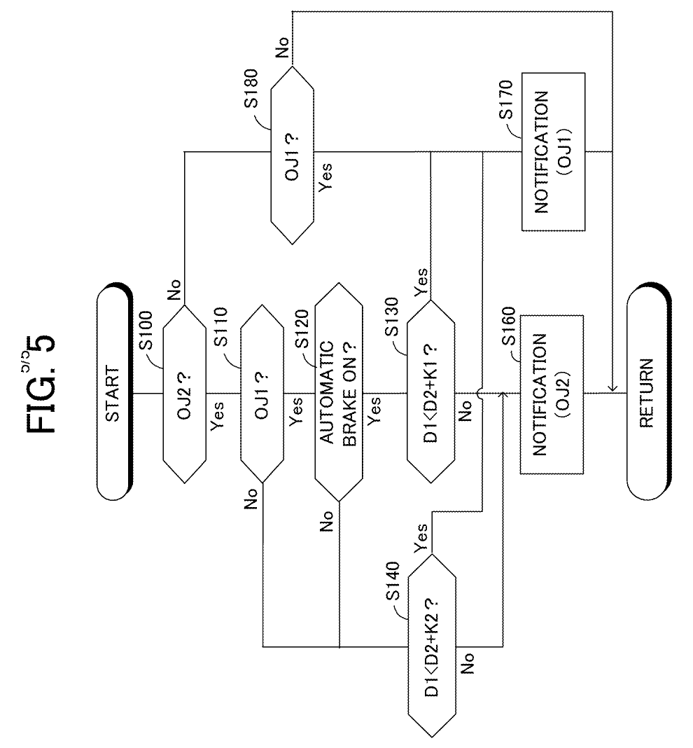

FIG. 5 is a flowchart for explaining routines of collision risk determination processing, priority processing, and notification processing executed by the CPU 11 of the ECU 10. This routine is started, for example, when the shift position becomes reverse R and the host vehicle VH starts reverse traveling.

In step S100, the ECU 10 detects a rear stationary object OJ2 based on detection results of the rear stationary object detection sensor 40B, and determines whether the detected rear stationary object OJ2 satisfies an execution condition of the stationary object notification processing. When the ECU 10 detects the rear stationary object OJ2 and the execution condition of the stationary object notification processing is satisfied (Yes), the ECU 10 proceeds to processing of step S110. On the other hand, when the ECU 10 does not detect the rear stationary object OJ2, or when the detected rear stationary object OJ2 does not satisfy the execution condition of the stationary object notification processing (No), the ECU 10 proceeds to processing of step S180.

When processing proceeds from step S100 to step S180, the ECU 10 detects a rear moving object OJ1 based on detection results of the rear moving object detection sensor 40A, and determines whether the detected rear moving object OJ1 satisfies an execution condition of the moving object notification processing. When the ECU 10 does not detect the rear moving object OJ1, or when the detected rear moving object OJ1 does not satisfy the execution condition of the moving object notification processing (No), the ECU 10 returns from this routine without executing the notification processing. On the other hand, when the ECU 10 detects the rear moving object OJ1 and the execution condition of the moving object notification processing is satisfied (Yes), the ECU 10 proceeds to processing of step S170 and executes the moving object notification processing. Thereafter, the ECU 10 returns from this routine.

When processing proceeds from step S100 to step S110, the ECU 10 detects a rear moving object OJ1 based on detection results of the rear moving object detection sensor 40A, and determines whether the detected rear moving object OJ1 satisfies the execution condition of the moving object notification processing. When the ECU 10 detects the rear moving object OJ1 and the execution condition of the moving object notification processing is satisfied (Yes), the ECU 10 proceeds to processing of step S120. On the other hand, when the ECU 10 does not detect the rear moving object OJ1, or when the detected rear moving object OJ1 does not satisfy the execution condition of the moving object notification processing (No), the ECU 10 proceeds to processing of step S160, executes the stationary object notification processing, and thereafter returns from this routine.

When processing proceeds from step S110 to step S120, the ECU 10 determines whether the automatic brake is ON. When the automatic brake is ON (Yes), the ECU 10 proceeds to processing of step S130. On the other hand, when the automatic brake is not ON (No), that is, when the automatic brake is OFF, the ECU 10 proceeds to processing of step S140.

In step S130, the ECU 10 determines whether a first distance D1 from the host vehicle VH to the first predicted collision position P1 is smaller than a value obtained by adding the first buffer constant K1 to a second distance D2 from the host vehicle VH to the second predicted collision position P2 (D1 < D2 + K1). When the first distance D1 is smaller than the value obtained by adding the first buffer constant K1 to the second distance D2 (Yes), the ECU 10 proceeds to processing of step S170. That is, in step S170, the ECU 10 executes the moving object notification processing. Thereafter, the ECU 10 returns from this routine. On the other hand, when the first distance D1 is not smaller than the value obtained by adding the first buffer constant K1 to the second distance D2 (No), the ECU 10 proceeds to processing of step S160. That is, in step S160, the ECU 10 executes the stationary object notification processing. Thereafter, the ECU 10 returns from this routine.

In step S140, the ECU 10 determines whether the first distance D1 from the host vehicle VH to the first predicted collision position P1 is smaller than a value obtained by adding the second buffer constant K2 to the second distance D2 from the host vehicle VH to the second predicted collision position P2 (D1 < D2 + K2). When the first distance D1 is smaller than the value obtained by adding the second buffer constant K2 to the second distance D2 (Yes), the ECU 10 proceeds to processing of step S170. That is, in step S170, the ECU 10 executes the moving object notification processing. Thereafter, the ECU 10 returns from this routine. On the other hand, when the first distance D1 is not smaller than the value obtained by adding the second buffer constant K2 to the second distance D2 (No), the ECU 10 proceeds to processing of step S160. That is, in step S160, the ECU 10 executes the stationary object notification processing. Thereafter, the ECU 10 returns from this routine.

The driving assistance apparatus and the driving assistance method according to the present embodiment have been described above; however, the present disclosure is not limited to the above embodiment, and various modifications are possible without departing from the object of the present disclosure.

For example, the first buffer constant K1 and/or the second buffer constant K2 is not limited to a fixed value, and may be a variable value corresponding to a distance between the host vehicle VH and a rear object. In this case, the buffer constants K1 and K2 may be set to be larger as the distance between the host vehicle VH and the rear object is longer. Further, the technology of the present disclosure is not limited to a case where the host vehicle VH is reverse-traveling, and can also be applied to a case where the host vehicle VH is forward-traveling. Further, the technology of the present disclosure can also be applied to an autonomously driven vehicle that automatically performs part or all of driving operations. In this case, the present disclosure may be configured to function when driving operations are switched from autonomous driving to manual driving.

What is claimed is:

1. . A driving assistance apparatus, comprising:
a first detection unit configured to detect a first object approaching, from outside a first region, toward the first region located in a traveling direction of a host vehicle and within a predetermined first distance range from the host vehicle;
a second detection unit configured to detect a second object present within a second region located in the traveling direction of the host vehicle and within a predetermined second distance range from the host vehicle;
a notification control unit configured to issue a warning to an occupant of the host vehicle when either
(i) a first notification condition is satisfied in which a first collision risk between the first object detected by the first detection unit and the host vehicle reaches a predetermined first level, or
(ii) a second notification condition is satisfied in which a second collision risk between the second object detected by the second detection unit and the host vehicle reaches a predetermined second level;
an automatic brake control unit configured to execute automatic braking by actuating a braking device of the host vehicle to apply braking force to the host vehicle when at least one of the first collision risk and the second collision risk reaches a predetermined third level;
a switching control unit configured to switch the automatic brake between an enabled state in which the automatic brake is executable and a disabled state in which the automatic brake is not executable, in accordance with satisfaction of a predetermined switching condition;
a risk determination unit configured to determine which of the first object and the second object has a higher collision risk when both the first notification condition and the second notification condition are satisfied; and
a priority control unit configured to control the notification control unit to preferentially issue a warning targeting the object determined by the risk determination unit to have the higher collision risk,
wherein the risk determination unit
acquires a first predicted collision position at which the host vehicle is predicted to collide with the first object and a second predicted collision position at which the host vehicle is predicted to collide with the second object,
compares a first predicted collision distance from the host vehicle to the first predicted collision position with a corrected second predicted collision distance obtained by adding a predetermined correction constant to a second predicted collision distance from the host vehicle to the second predicted collision position, and
determines that the object having a smaller value has the higher collision risk, and
wherein the risk determination unit sets the correction constant to be smaller when the automatic brake is switched to the enabled state by the switching control unit than when the automatic brake is switched to the disabled state.

2. . The driving assistance apparatus according to claim 1,
wherein the predetermined switching condition includes acquisition of a switching request from the occupant.

3. . The driving assistance apparatus according to claim 1,
wherein the risk determination unit sets the correction constant to a predetermined first correction constant when the automatic brake is switched to the enabled state by the switching control unit,
sets the correction constant to a predetermined second correction constant when the automatic brake is switched to the disabled state, and
sets the first correction constant within a range from zero to a value smaller than the second correction constant.

4. . The driving assistance apparatus according to claim 1,
wherein the risk determination unit sets the correction constant to a maximum detection error of the second detection unit when the automatic brake is switched to the disabled state by the switching control unit.

5. . A driving assistance method, comprising:
detecting a first object approaching, from outside a first region, toward the first region located in a traveling direction of a host vehicle and within a predetermined first distance range from the host vehicle;
detecting a second object present within a second region located in the traveling direction of the host vehicle and within a predetermined second distance range from the host vehicle;
executing notification control to issue a warning to an occupant of the host vehicle when either
(i) a first notification condition is satisfied in which a first collision risk between the detected first object and the host vehicle reaches a predetermined first level, or
(ii) a second notification condition is satisfied in which a second collision risk between the detected second object and the host vehicle reaches a predetermined second level;
executing automatic braking by actuating a braking device of the host vehicle to apply braking force to the host vehicle when at least one of the first collision risk and the second collision risk reaches a predetermined third level;
executing switching control to switch the automatic brake between an enabled state and a disabled state in accordance with satisfaction of a predetermined switching condition;
executing determination processing to determine which of the first object and the second object has a higher collision risk when both the first notification condition and the second notification condition are satisfied;
executing the notification control to preferentially issue a warning targeting the object determined to have the higher collision risk,
wherein the determination processing includes
acquiring a first predicted collision position and a second predicted collision position,
comparing a first predicted collision distance with a corrected second predicted collision distance obtained by adding a predetermined correction constant to a second predicted collision distance, and
determining that the object having a smaller value has the higher collision risk, and
wherein the correction constant is set to be smaller when the automatic brake is in the enabled state than when the automatic brake is in the disabled state.
